(19) United States
(12) Patent Application Publication
(10) Pub. No.: US 2008/0095491 A1
(43) Pub. Date: Apr. 24, 2008

(54) Integrated Optical Wave Guide for Light Generated by a Bipolar Transistor

(76) Inventors: Johan Hendrik Klootwijk, Eindhoven (NL); Freddy Roozeboom, Waaire (NL)

Correspondence Address: PHILIPS ELECTRONICS NORTH AMERICA CORPORATION;INTELLECTUAL PROPERTY & STANDARDS, 370 W. TRIMBLE ROAD MS 91/MG, SAN JOSE, CA, 95131, US

(21) Appl. No.: 10/588,836

(22) PCT Filed: Feb. 11, 2005
(86) PCT No.: PCT/IB05/50528

§ 371 Date: Aug. 7, 2007

Related U.S. Application Data
(60) Provisional application No. 60/543,948, filed on Feb. 11, 2004.

(51) Int. Cl. G02B 6/12

(52) U.S. Cl. 385/14

(57) ABSTRACT

A monolithically integrated optical network device (20). The device comprises: a bipolar transistor (10) realized in a silicon substrate (11) that can be biased into an avalanche condition to emit photons; and a photonic bandgap (PBG) structure (22) monolithically integrated with the bipolar transistor (10) to act as an optical wave guide (16) for the photons generated by the bipolar transistor (10).

The present invention relates generally to the transmission of data at the silicon level, and relates more specifically to a wave guide integrated with a bipolar transistor for conducting light generated by the bipolar transistor.

As computer chip technology continues to evolve, the ability to further enhance the processing and transmission performance of data at the silicon level remains an ongoing challenge. Traditionally, information is processed and transmitted electrically over small metallic wires that interconnect silicon-based devices, such as transistors and/or other electrical components. However, transmitting electricity over wires is subject to certain limitations, including limited transmission speeds, electromagnetic interferences, etc.

One potential solution to overcome some of the limitations of electrical transmission is to utilize pulsed light to carry information. However, in order to implement such an optical network, systems are required: (1) for generating light at the silicon level, and (2) for transmitting the light from one silicon based device to another.

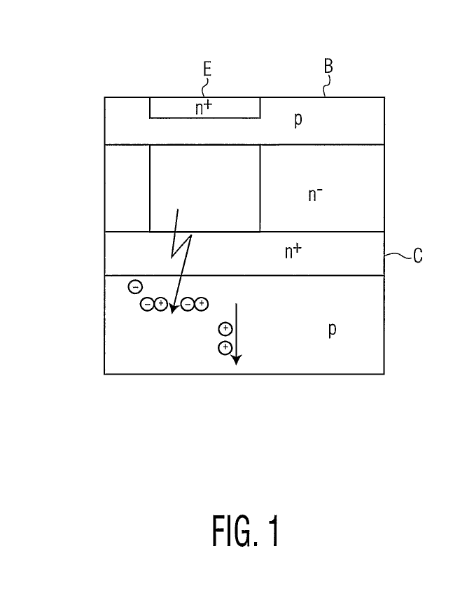

In the art, it is known that when a bipolar transistor is biased into avalanche, light is generated in the reverse biased collector-base diode. The amount of light can be tuned by both the collector-base voltage as well as the current through the device (unlike an avalanche diode, which is commonly used). This enables light generation at very low current densities. The substrate current can be a measure for the amount of generated light. The typical wavelength of the generated light is λ<1 μm (i.e., near-infrared light for lightly-doped silicon). FIG. 1 depicts an example of a model for generating light from a bipolar transistor, where E is the emitter, C is the collector, B is the base, and SUB is the measure of substrate current. Details of such an embodiment are described, for instance, in J. H. Klootwijk, J. W. Slotboom, M. S. Peter, Photo Carrier Generation in Bipolar Transistors, IEEE Trans. Electron Devices, Vol. 49 (No. 9), pp. 1628, 2002, September 2002, which is hereby incorporated by reference.

Unfortunately, no effective solution exists for conducting light from the bipolar transistor to other locations in silicon. Accordingly, a need exists for a system for conducting light at the silicon level from a bipolar transistor to other devices in the silicon.

The present invention addresses the above-mentioned problems, as well as others by providing an integrated optical wave guide for conducting light generated by a bipolar transistor. In a first aspect, the invention provides a monolithically integrated optical network device, comprising: a bipolar transistor realized in a silicon substrate that can be biased into an avalanche condition to emit photons; and a photonic bandgap (PBG) structure monolithically integrated with the bipolar transistor to act as an optical wave guide for the photons emitted by the bipolar transistor.

In a second aspect, the invention provides a monolithically integrated optical network, comprising: a bipolar transistor realized in a silicon substrate that can be biased into an avalanche condition to emit photon pulses; a photonic bandgap (PBG) structure monolithically integrated with the bipolar transistor in the silicon substrate that acts as an optical wave guide for the photon pulses generated by the bipolar transistor; and a receiving device realized proximate a distal end of the optical wave guide for receiving the photon pulses generated by the bipolar transistor.

These and other features of this invention will be more readily understood from the following detailed description of the various aspects of the invention taken in conjunction with the accompanying drawings in which:

FIG. 1 depicts a bipolar transistor reverse biased into an avalanche condition to emit photons in accordance with the present invention.

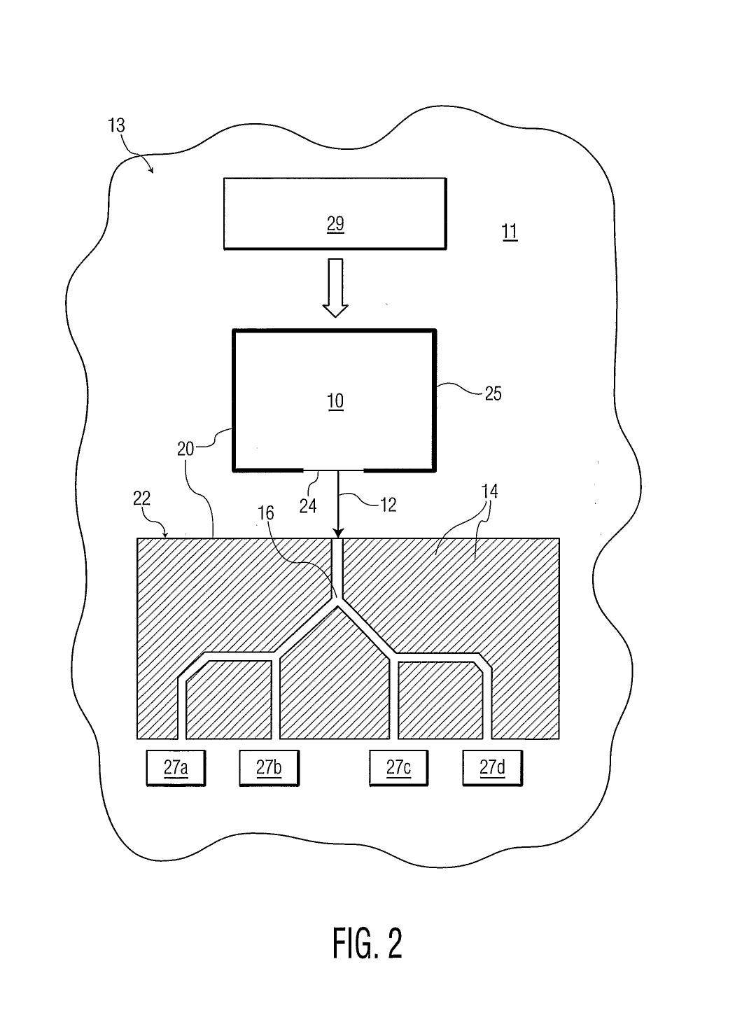

FIG. 2 depicts a silicon based optical network in accordance with the present invention.

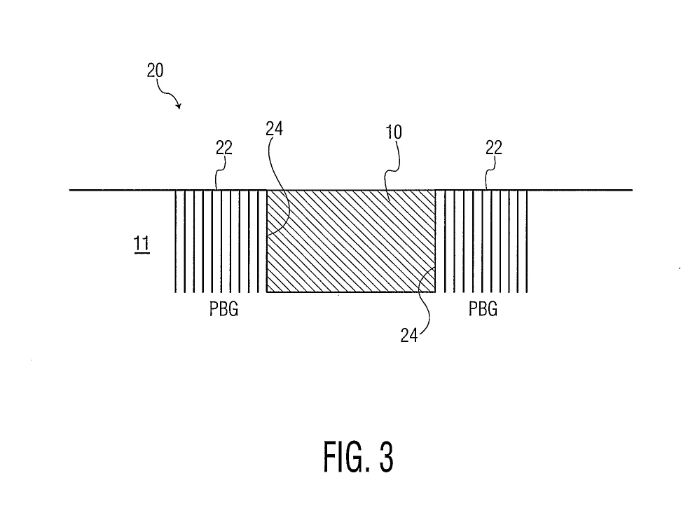

FIG. 3 depicts a side view of a monolithically integrated optical network device in accordance with the present invention.

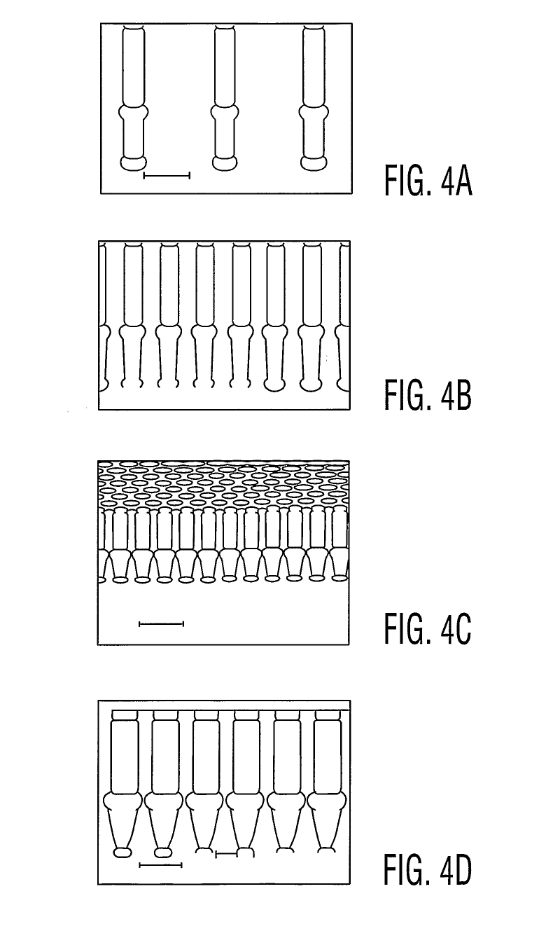

FIG. 4 depicts four cross-sectional micrographs of exemplary photonic band gap (PBG) structures in a silicon wafer after dry etching with a mask.

The present invention provides an optical wave guide structure that is combined and monolithically integrated with a bipolar device, resulting in a low-current density light source with an integrated optical wave guide. In this way, light generated in the bipolar transistor can be transported through a silicon wafer, and serve as a basic element/structure in an optical network.

In particular, the present invention utilizes “photonic bandgap” (PBG) structures to act as optical wave guides for light generated by a monolithically integrated bipolar device. The PBG structures comprise corrugated channel-cage structures, which may be dry-etched in silicon. In an exemplary embodiment, PBG structures are implemented as two-dimensional (2D) crystals consisting of parallel cylinders (or elements) that can be readily realized at submicron lengths. Alternatively, as technology advances, photonic crystals with three-dimensional (3D) periodicity could likewise be utilized. A more complete discussion of PBG structures can be found, e.g., in U.S. Pat. No. 5,987,208, “Optical Structure and Method for its Production,” issued to Gruning et al., on Nov. 16, 1999, which is hereby incorporated by reference.

Referring to FIG. 2, a top view of an optical network 13 fabricated within a silicon substrate 11 is shown. Optical communication is achieved with a monolithically integrated optical network device 20 etched into silicon substrate 11. Device 20 includes: (1) a bipolar transistor 10 capable of emitting a light signal 12, i.e., photon beam, from a base-collector junction 24, and (2) a PBG structure 22 having a plurality of PBG elements 14 that define a wave guide channel 16. As can be seen, the light signal 12 can be “bent” and “split” through the wave guide channel 16, thereby allowing the light source to be directed to any one or more points in the silicon substrate 11. PBG elements 14 are strategically located as needed throughout the silicon substrate 11 to create the desired wave guide configuration. Possible configurations may include wave guides channels with multiple branches (i.e., beam splitters), channels that interconnect devices internally within the silicon substrate 11, channels that interconnect devices with external devices, etc.

In the exemplary embodiment shown in FIG. 2, the wave guide is connected to a plurality of receiving devices 27a-d (e.g., photo-diodes) that receive pulsed light sources from the bipolar transistor 10. Control over the network 13 can be provided by control system 29, which may include, e.g., a microprocessor or other logic that dictates when light should be transmitted from the bipolar transistor 10. Control system 29 may reside within the silicon substrate 11 and/or externally to the substrate.

As noted above, under the appropriate conditions, bipolar transistors will emit photons (i.e., light) into the surrounding substrate. This condition specifically occurs when the collector-base diode of the transistor is reverse biased into avalanche. Any biasing values that achieve an avalanche condition may be utilized, e.g., for a typical n-p-n device, V_{BE}=0.82 V, V_{CB}=3 V, and V_{CS}=−1 V.

To increase the effectiveness of the emitted light, bipolar transistor 10 may be fabricated with a reflective material 25 on one or more surfaces to block photon emission and thereby cause the light source 12 to be directed out of one or more surfaces. Furthermore, the reflective material 25 may be selectively placed on the transistor's surfaces to define an optical window 24 through which the light source 12 will be focused. In an exemplary embodiment, the reflective material 25 can comprise a so-called ½ λ-layer that has the right optical properties (refractive index and optical thickness) to bring about the reflection and thus the confinement of the emitted light 12. To this end, the optical reflective layer can be deposited in vertical trenches (not shown) that are first etched around the bipolar light source. The subsequent deposition can be performed by, e.g., LPCVD, low-pressure chemical deposition. The trench width should have a width that corresponds with half the wavelength of the emitted light (½ λ) in the optical reflection layer.

Referring now to FIG. 3, a cross-sectional side view of the monolithically integrated optical network device 20 is shown. In a typical present day implementation, bipolar transistors are isolated laterally by deep trench isolation. In accordance with the present invention, instead of etching deep trenches for isolation purposes, corrugated-channel cage structures that form the optical wave guides are patterned, e.g., using a dry-etch process, in the silicon substrate 11. Since the PBG structure 22 can be etched close to the base-collector junction 24 of a bipolar transistor 10, an optical wave guide can be generated close to the source of the light, and further increase the efficiency of the bipolar light source.

In accordance with an exemplary embodiment of the invention, the steps involved in fabricating the monolithically integrated optical network device 20 are as follows: (1) fabricate the bipolar transistor 10; and (2) etch a PBG wave guide structure 22 proximate a region wherein the bipolar transistor 10 is located, such that transistor 10 is monolithically integrated with the PBG wave guide structure 22.

FIG. 4 depicts four cross-sectional micrographs of exemplary photonic band gap (PBG) structures in a silicon wafer after dry etching with a mask. Each cylinder element essentially comprises a “pore” through the silicon. In these four embodiments, the mask hole diameter and pitch are (a) 2 μm and, 10 μm, (b) 1.5 μm and 3.5 μm, (c) and (d) 3 μm and 5 μm. Obviously, the particular diameter and pitch of the PBG structure 22 can vary according to the particular application. In addition, it should be understood that the PBG structure 22 can be fabricated with a wet chemical etch process.

Typically the pores in the PBG structure 22 have a round cross section and are arranged in a square or hexagonal array to make the structure suitable for guiding polarized light and non-polarized light, respectively. Exemplary pore diameters are of the order of 1 μm, and the pitch a between the pores is only slightly larger. The wavelength λ can be tailored by setting the pitch a, the relationship being: α/λ=0.2 to 0.5. This implies that a complete wavelength range can be covered from the near to the far infrared, e.g., 0.9 μm (typical SiGe bandgap) and 1.1 μm (Si bandgap) to ˜100 μm. Example: for λ=5-6 μm, pitch α=1.5-2.5 μm. Typical characteristic pore diameter and pitch values for a PBG structure can be, depending on the wavelength of the light to be guided, of the order of 300 nm (for visible light guiding) to a few μm (for infrared light guiding).

Any methodology may be employed to realize the PBG structure 22. One way of manufacturing the PBG structure is by electrochemical etching, e.g. photo-electrochemical etching of lightly n-doped silicon, with the silicon wafer connected as the anode and containing a pre-etched array of micro-indentations that serve as starting points for the pores of the array to be etched after the micro-indentation. By varying the photo-irradiation intensity of the wafer backside, i.e., the current density, during the electrochemical etching the pore radius can be changed periodically. The pore array that makes up the PBG structure 22 could also be realized by using dry etching, i.e., reactive ion etching (RIE). In addition, the PBG structure 22 could be realized with the corrugated pillars remaining, thus creating the inverse structure of an array of pillars instead of pores.

One dry-etching technique for making the necessary corrugated pore array structures involves the so-called “Bosch process.” This process is a dry-etching process enabling high aspect ratio trenches and pores. Etching is done in SF₆ chemistry as opposed to passivation, which is done in C₄F₈ chemistry. By changing the process parameters such that one alternatively enters and leaves the process window from anisotropic into isotropic etching, these corrugated structures can be made. The silicon etch process is based on plasma etching where rapidly switching of etching and passivation chemistry enables the formation of pores, trenches, etc.

An exemplary process may use the following steps:

(1) Etching and passivation as in the Bosch process, until the desired depth of the first corrugation.

(2) Step 1 ends with an etch cycle. This is required since the passivation polymer on the bottom of the pore has to be removed in order to enable the next isotropic etching step,

(3) Isotropic etching by using SF₆/o₂ chemistry. During the isotropic step the platen power (bias voltage on the chuck supporting the wafer) is switched off to reduce the ion-assisted etching and to maximize the chemically assisted etching by radicals and neutrals, and thus to improve isotropic etching of silicon.

(4) After the isotropic etch step, the process switches to the next step, starting this time with a passivation cycle; this to cover and protect the complete structure etched thus far with a passivation layer. Next, the process resumes step 1 again and can be repeated several times.

Generally speaking, the optical wave guide may consist of a high refractive index core with a lower refractive index cladding. Typical combinations that can be use include: TiO2 core and SiO2 cladding; Si3N4 core and SiO2 cladding; SiON core and SiO2 cladding; PMMA core and Cr cladding; Poly Si core and SiO2 cladding; and InGaAsP core and InP cladding.

It should be noted that the silicon substrate may comprise a binary or ternary Si compound semiconductor alloy, such as SiGe and SiGeC. The compounds are more specifically written as Si_{1-X} and Si_{1-X-Y}Ge_{X}C_{y} with x typically in the fractional range of 0.2<x<0.3 and y typically <0.01. By selecting the right alloy composition, one can “tune” the semiconductor bandgap to a wider range of bandgaps, and thus a wider range of emitted light wavelengths (referred to as bandgap engineering).

The foregoing description of the preferred embodiments of the invention has been presented for purposes of illustration and description. They are not intended to be exhaustive or to limit the invention to the precise form disclosed, and obviously many modifications and variations are possible in light of the above teachings. Such modifications and variations that are apparent to a person skilled in the art are intended to be included within the scope of this invention as defined by the accompanying claims.

1. A monolithically integrated optical network device, comprising: a bipolar transistor realized in a silicon substrate that can be biased into an avalanche condition to emit photons; and a photonic bandgap (PBG) structure monolithically integrated with the bipolar transistor to act as an optical wave guide for the photons emitted by the bipolar transistor.

2. The monolithically integrated optical network device of claim 1, wherein the bipolar transistor includes a surface covered in a reflective material that blocks emission of photons through the surface.

3. The monolithically integrated optical network device of claim 2, wherein the surface includes an optical window that allows photons to pass from the bipolar transistor to the surrounding silicon substrate.

4. The monolithically integrated optical network device of claim 2, wherein the reflective material comprises a ½ λ-layer.

5. The monolithically integrated optical network device of claim 3, wherein the PBG structure includes a plurality of porous columns realized in the silicon substrate adjacent to the optical window defined on the surface of the bipolar transistor.

6. The monolithically integrated optical network device of claim 5, wherein the plurality of porous columns are arranged to define a channel that provides the wave guide for the photons emitted through the optical window.

7. The monolithically integrated optical network device of claim 1, wherein the emission of light from the bipolar transistor is regulated by a control system.

8. The monolithically integrated optical network device of claim 1, wherein the bipolar transistor is fabricated from a material selected from the group consisting of: SiGe, SiGeC, InP, and GaAs.

9. The monolithically integrated optical network device of claim 1, wherein the silicon substrate is fabricated from a material selected from the group consisting of: CMOS, SiGe, SiGeC, and BiCMOS.

10. A monolithically integrated optical network, comprising: a bipolar transistor realized in a silicon substrate that can be biased into an avalanche condition to emit photon pulses; a photonic bandgap (PBG) structure monolithically integrated with the bipolar transistor in the silicon substrate that acts as an optical wave guide for the photon pulses generated by the bipolar transistor and a receiving device realized proximate a distal end of the optical wave guide for receiving the photon pulses generated by the bipolar transistor.

11. The monolithically integrated optical network of claim 10, further comprising a control system for regulating the emission of photon pulses from the bipolar transistor.

12. The monolithically integrated optical network of claim 10, wherein the receiving device comprises a photo diode.

13. The monolithically integrated optical network of claim 10, wherein the bipolar transistor includes a surface covered in a reflective material that blocks emission of photons pulses through the surface.

14. The monolithically integrated optical network of claim 13, wherein the surface includes an optical window that allows photon pulses to pass from the bipolar transistor to the surrounding silicon substrate.

15. The monolithically integrated optical network of claim 14, wherein the PBG structure includes a plurality of porous columns realized in the silicon substrate adjacent to the optical window defined on the surface of the bipolar transistor.

16. The monolithically integrated optical network of claim 15, wherein the plurality of porous columns are arranged to define a channel that provides the wave guide for the photons emitted through the optical window.

17. The monolithically integrated optical network of claim 13, wherein the reflective material comprises a ½ λ-layer.

18. The monolithically integrated optical network of claim 10, wherein the bipolar transistor is fabricated from a material selected from the group consisting of: SiGe, SiGeC, InP, and GaAs.

19. The monolithically integrated optical network of claim 10, wherein the silicon substrate is fabricated from a material selected from the group consisting of: CMOS, SiGe, SiGeC, and BiCMOS.
